(19) United States
(12) Patent Application Publication
(10) Pub. No.: US 2005/0008259 A1
(43) Pub. Date: Jan. 13, 2005

(54) Method and device for changing image size

(75) Inventors: Yoshimasa Kondo, Matsumoto-shi (JP); Takashi Shindo, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/851,334

(22) Filed: May 24, 2004

(30) Foreign Application Priority Data
May 28, 2003 (JP) 2003-150847

(51) Int. Cl. G06K 9/32; G06K 9/36

(52) U.S. Cl. 382/299; 382/232

(57) ABSTRACT

A method of changing an image size includes changing a size of the original image at least in a horizontal direction by interpolating data in an interpolation pixel between predetermined pixels in each of the unit areas of the original image according to a set horizontal increasing scale factor. Each of the unit areas includes a plurality of first boundary pixels arranged along a vertical virtual boundary line between two of the unit areas adjacent in the horizontal direction in the frame. In the image size changing step, the interpolation pixel is set between pixels other than the first boundary pixels.

Japanese Patent Application No. 2003-150847, filed on May 28, 2003, is hereby incorporated by reference in its entirety.

### BACKGROUND OF THE INVENTION

The present invention relates to a method and a device for changing an image size which can change the size of an original image having a processing history of Moving Picture Experts Group (MPEG) compression or decompression or the like.

Conventionally, data is interpolated in interpolation pixels between pixels when increasing the image size, and data in thinning pixels is omitted when reducing the image size.

However, a flicker occurs on the screen or coarseness becomes conspicuous when this method is used for an image having a processing history of MPEG-4 compression or decompression, whereby the image quality deteriorates.

The present inventors have found that processing performed during compression or decompression in units of unit areas, which are defined by diving one frame, is relevant to deterioration of the image quality.

### BRIEF SUMMARY OF THE INVENTION

Accordingly, the present invention may provide a method and a device for changing an image size which can increase or reduce the size of the original image having a processing history of compression or decompression in units of unit areas without deteriorating the image quality.

A method of changing an image size according to one aspect of the present invention includes:

storing an original image that has been processed in units of unit areas which are defined by dividing one frame; and

changing a size of the original image at least in a horizontal direction by interpolating data in an interpolation pixel between predetermined pixels in each of the unit areas of the original image according to a set horizontal increasing scale factor,

wherein each of the unit areas includes a plurality of first boundary pixels arranged along a vertical virtual boundary line between two of the unit areas adjacent in the horizontal direction in the frame, and

wherein, in the image size changing step, the interpolation pixel is set between pixels other than the first boundary pixels.

Another aspect of the present invention defines a device which implements this method.

The original image, which is the processing target of the method and the device of the present invention, has a processing history of being processed in units of unit areas which are defined by diving one frame. Each unit area is adjacent to another unit area in the horizontal direction or the vertical direction in one frame. In two unit areas adjacent in the horizontal direction, the correlation of data is comparatively small even if the pixels are adjacent to each other, since a unit for processing of the first boundary pixels arranged along the vertical virtual boundary line between the two unit areas differs between one unit area and the other unit area.

Therefore, if data in the first boundary pixel is used as interpolation data for the interpolation pixel, the boundary between two unit areas is emphasized, whereby the vertical virtual boundary line becomes conspicuous on the screen.

In the present invention, since data in the first boundary pixel is prevented from being used as interpolation data, the image quality can be maintained even if the image size is increased in the horizontal direction.

The present invention may also be applied to the case of increasing the size of the original image in the vertical direction.

In this case, each of the unit areas may include a plurality of second boundary pixels arranged along a horizontal virtual boundary line between two of the unit areas adjacent in the vertical direction in the frame, and the image size changing step may further include increasing size of the original image in the vertical direction by setting the interpolation pixel between pixels other than the second boundary pixels according to a set vertical increasing scale factor.

Since data in the second boundary pixel is prevented from being used as interpolation data, the image quality can be maintained even if the image size is increased in the vertical direction.

The present invention may also be applied to the case of reducing the size of the original image in the horizontal direction.

In this case, the image size changing step may further include reducing and changing size of the original image in the horizontal direction by thinning out data in a thinning pixel according to a set horizontal reduction scale factor, the thinning pixel being a pixel other than the first boundary pixels in each of the unit areas.

Since data in the first boundary pixel is prevented from being thinned out, the image quality can be maintained even if the image size is reduced in the horizontal direction.

The present invention may also be applied to the case of reducing the size of the original image in the vertical direction.

In this case, the image size changing step may further include reducing and changing size of the original image in the vertical direction by thinning out data in a thinning pixel according to a set vertical reduction scale factor, the thinning pixel being a pixel other than the second boundary pixels in each of the unit areas.

Since data in the second boundary pixel is prevented from being thinned out, the image quality can be maintained even if the image size is reduced in the vertical direction.

As the original image having a processing history of being processed in units of unit areas, an image compressed or decompressed by an MPEG method can be used, for example.

The original image that has been compressed or decompressed by the MPEG method may be processed in units of 8×8 pixel blocks during a discrete cosine transform or inverse discrete cosine transform. In this case, each of the unit areas may correspond to the block. Therefore, the (n×8 th pixels and the (n×8+1)th pixels in the horizontal direction and the vertical direction in one frame are boundary pixels. Note that “n” is a positive integer.

The original image that has been compressed or decompressed by the MPEG method may be processed in units of 16×16 pixel macroblocks during motion compensation or inverse motion compensation. Therefore, each of the unit areas may correspond to the macroblock. In this case, the (n×16)th pixels and the (n×16+1)th pixels in the horizontal direction and the vertical direction in one frame are boundary pixels.

The data interpolation step may include obtaining data in the interpolation pixel by averaging data in pixels adjacent to the interpolation pixel. The data thinning step may include averaging data in a pixel that is adjacent to the thinning pixel and other than the first or second boundary pixels by using the thinning pixel. This reduces emphasis of brightness or color in comparison with the case where data is not averaged, whereby an image quality close to that of the original image can be maintained.

In the case where the original image is a color image, the size of an image made up of RGB components may be changed. However, a color image made up of YUV components may be the target of processing. In the latter case, the averaging step may be performed for only the Y component which dominates the sense of color.

With the device for changing an image size according to the other aspect of the present invention, the image size changing circuit may include: horizontal direction changing circuit which changes the image size in the horizontal direction; and vertical direction changing circuit which changes the image size in the vertical direction.

In this case, at least one of the horizontal direction changing circuit and the vertical direction changing circuit may include: a first buffer to which data in the n-th pixel (n is a positive integer) in the horizontal or vertical direction is input; a second buffer to which data in the (n+1)th pixel in the horizontal or vertical direction is input; an operation section which averages the data in the n-th pixel and the (n+1)th pixel; a third buffer to which an output from the operation section is input; and a selector which selects one of outputs from the first to third buffers.

When a scale factor is an increasing scale factor, the selector may select and output the output from the third buffer to the interpolation pixel. When a scale factor is a reduction scale factor, the selector may select and output the output from the third buffer to a pixel adjacent to the thinning pixel.

### BRIEF DESCRIPTION OF THE SEVERAL VIEWS OF THE DRAWING

FIG. 1 is a schematic block diagram of a portable telephone which is an example of an electronic instrument to which the present invention is applied.

FIG. 2A is a flowchart showing processing procedure in an MPEG encoder, and FIG. 2B is a flowchart showing processing procedure in an MPEG decoder.

FIG. 3 shows one block and one macroblock which are processing units in an MPEG encoder and an MPEG decoder.

FIG. 4 shows an example of DCT coefficients obtained by a discrete cosine transform (DCT).

FIG. 5 shows an example of a quantization table used during quantization.

FIG. 6 shows quantized DCT coefficients (QF data) obtained by dividing the DCT coefficients shown in FIG. 4 by values in the quantization table shown in FIG. 5.

FIG. 7 is a block diagram illustrating a configuration relating to an MPEG decoder among the sections shown in FIG. 1.

FIG. 8 is illustrative of an operation when the scale factor is set at 1.25.

FIG. 9 is illustrative of an operation when the scale factor is set at 0.75.

FIG. 10 shows an enlarged image in which averaged data is used as interpolation pixel data shown in FIG. 10.

FIG. 11 shows a reduced image in which thinning pixel data shown in FIG. 11 and remaining pixel data are averaged.

FIG. 12 is a block diagram showing an example of horizontal and vertical direction size changing sections shown in FIG. 7.

FIG. 13 is a timing chart showing a basic operation of a circuit shown in FIG. 12.

FIG. 14 is a timing chart showing an operation of generating data of the enlarged image shown in FIG. 10 using the circuit shown in FIG. 12.

FIG. 15 is a timing chart showing an operation of generating data of the reduced image data shown in FIG. 11 using the circuit shown in FIG. 12.

### DETAILED DESCRIPTION OF THE EMBODIMENT

An embodiment of the present invention is described below with reference to the drawings.

Outline of Portable Telephone

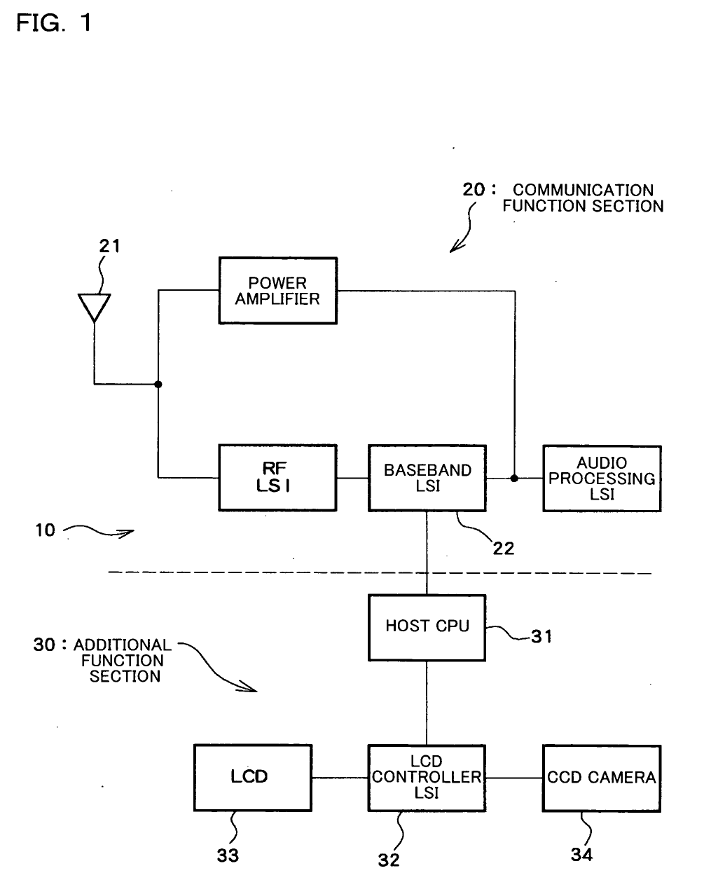

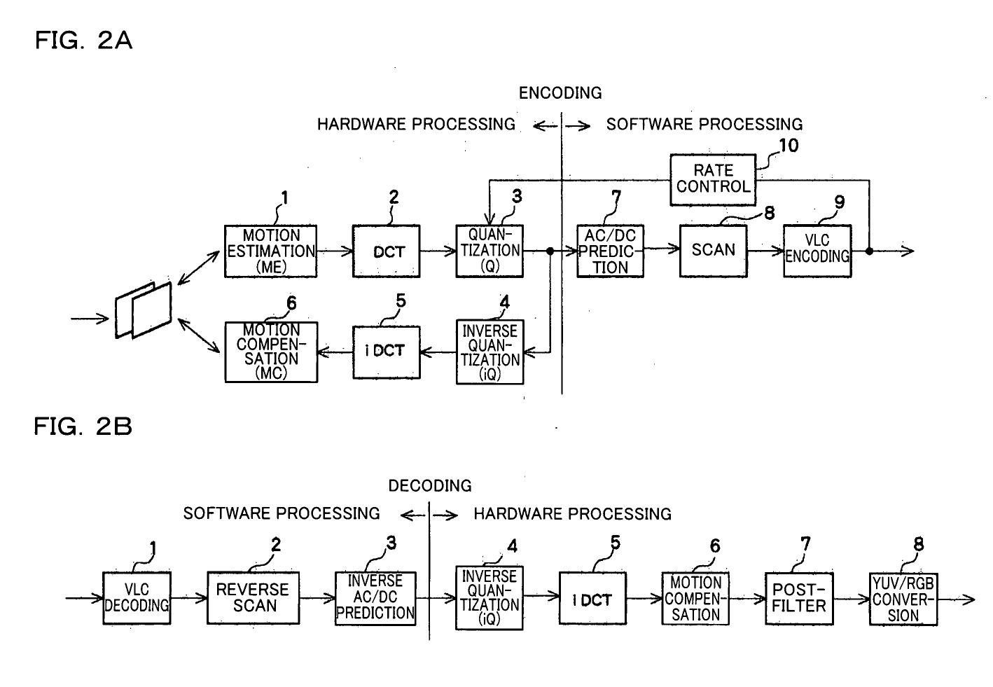

FIG. 1 is a block diagram of a portable telephone which is an example of an electronic instrument to which the present invention is applied. In FIG. 1, a portable telephone 10 is roughly divided into a communication function section 20 and an additional function section 30. The communication function section 20 includes various conventional blocks which process a signal (including a compressed moving image) transmitted and received through an antenna 21. A baseband LSI 22 in the communication function section 20 is a processor which mainly processes voice or the like, and is necessarily provided in the portable telephone 10. The baseband LSI 22 is provided with a baseband engine (BBE), an application processor, and the like. Software on the processor performs MPEG-4 compression (encode) processing shown in FIG. 2A, including variable length code (VLC) encoding, scanning, AC/DC (alternating current/direct current component) prediction, and rate control. The software on the processor provided in the baseband LSI 22 performs MPEG-4 decompression (decode) processing shown in FIG. 2B, including VLC decoding, reverse scanning, and AC/DC prediction. The remaining MPEG-4 decode and encode processing is performed by hardware provided in the additional function section 30.

The additional function section 30 includes a host central processing unit (CPU) 31 connected with the baseband LSI 21 in the communication function section 20. An LCD controller LSI 32 is connected with the host CPU 31. A liquid crystal display device (LCD) 33 as an image display section and a CCD camera 34 as an imaging section are connected with the LCD controller LSI 32. The hardware processing of MPEG-4 encoding and decoding and hardware processing for changing the image size are performed by hardware provided in the LCD controller LSI 32.

MPEG-4 Encoding and Decoding

The MPEG-4 encode and decode processing shown in FIGS. 2A and 2B is briefly described below. The details of the processing are described in “JPEG & MPEG: Illustrated Image Compression Technology”, Hiroshi Ochi and Hideo Kuroda, Nippon Jitsugyo Publishing Co., Ltd., for example. In the following description, only the processing relating to the present invention is mainly described.

In the compression (encode) processing shown in FIG. 2A, motion estimation (ME) between two successive images is performed (Step 1). In more detail, the difference between the two images is calculated for a single pixel. Since the difference between the two images is zero in the still image region, the amount of information can be reduced. The zero data in the still image region and the difference (positive and negative component) in the moving image region make up information after the motion estimation.

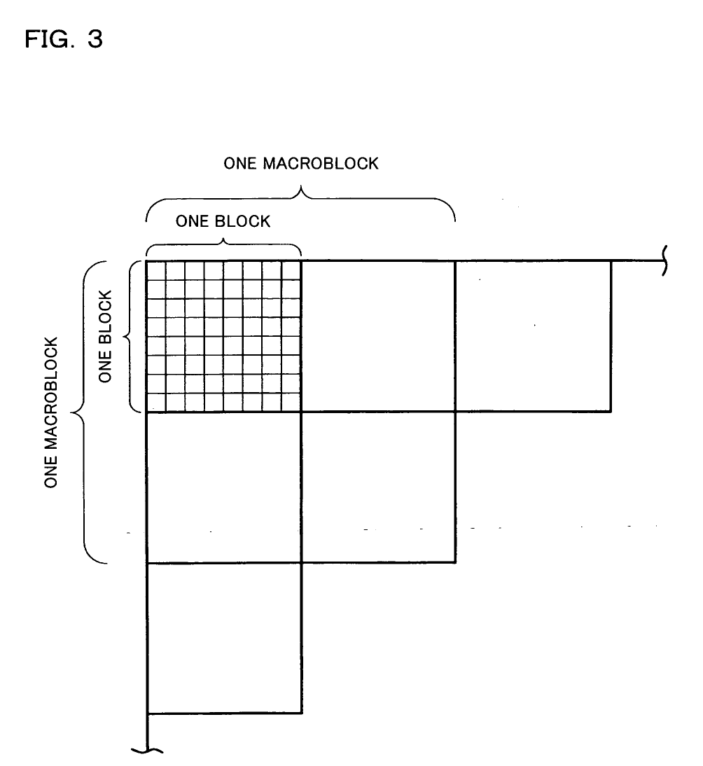

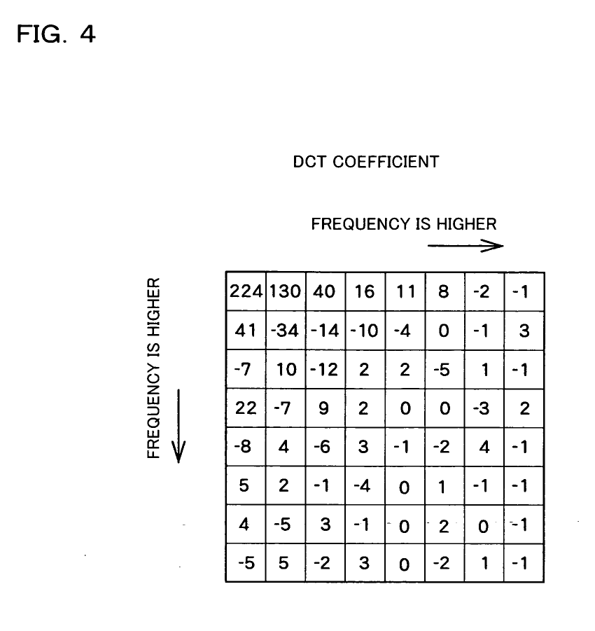

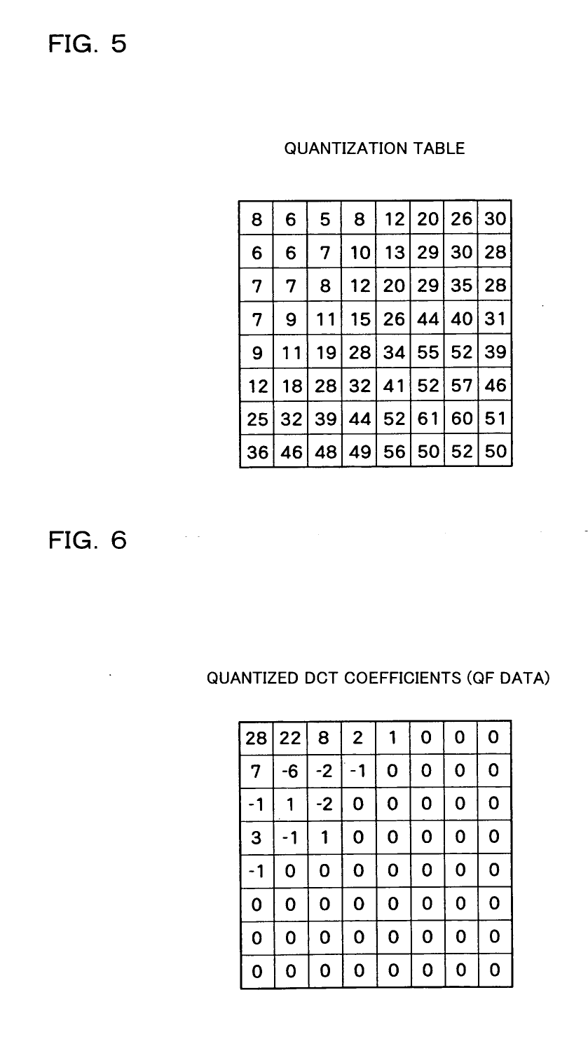

A discrete cosine transform (DCT) is then performed (Step 2). The discrete cosine transform is performed in units of 8×8 pixel blocks shown in FIG. 3 to calculate DCT coefficients in units of blocks. The DCT coefficients after the discrete cosine transform represent changes in light and shade of the image in one block by average brightness (DC component) and spatial frequency (AC component). FIG. 4 shows an example of the DCT coefficients in one 8×8 pixel block (quotation from FIGS. 5 and 6 on page 116 in the above reference document). The DCT coefficient on the upper left corner represents a DC component, and the remaining DCT coefficients represent AC components. The influence on image recognition is small even if high-frequency AC components are omitted.

The DCT coefficients are then quantized (Step 3). The quantization is performed in order to reduce the amount of information by dividing the DCT coefficients in one block by quantization step values at corresponding positions in a quantization table. FIG. 6 shows the DCT coefficients in one block obtained by quantizing the DCT coefficients shown in FIG. 4 using a quantization table shown in FIG. 5 (quotation from FIGS. 5-9 and 5-10 on page 117 in the above reference document). As shown in FIG. 6, the majority of the DCT coefficients become zero data after dividing the DCT coefficients of high frequency components by quantization step values and rounding off to the nearest whole number, whereby the amount of information is significantly reduced.

A feed-back route is necessary for the encode processing in order to perform the motion estimation (ME) between the currently processed frame and the subsequent frame. As shown in FIG. 2A, inverse quantization (iQ), inverse DCT, and motion compensation (MC) are performed through the feed-back route (Steps 4 to 6). The detailed operation of motion compensation is omitted. This processing is performed in units of 16×16 pixel macroblocks shown in FIG. 3.

The series of processing in Steps 1 to 6 is performed by the hardware provided in the LCD controller LSI 32 of this embodiment.

AC/DC prediction, scanning, VLC encoding, and rate control performed by the software on the processor provided in the baseband LSI 22 shown in FIG. 1 are described below.

AC/DC prediction performed in Step 7 and scanning performed in Step 8 shown in FIG. 2A are processing necessary for VLC encoding in Step 9. In VLC encoding in Step 9, the difference in the DC component between adjacent blocks is encoded, and the order of encoding is determined by scanning the AC components in the block from the low frequency side to the high frequency side (also called “zigzag scan”).

VLC encoding in Step 9 is also called entropy encoding, and has an encoding principle in which a component with higher emergence frequency is represented by using a smaller number of codes. The difference in the DC component between adjacent blocks is encoded, and the DCT coefficients of the AC components are sequentially encoded from the low frequency side to the high frequency side in the order of scanning by utilizing the results obtained in Steps 7 and 8.

The amount of information generated by image signals changes depending on complexity of the image and intensity of motion. In order to transmit the information at a constant transmission rate by absorbing the change, it is necessary to control the number of codes to be generated. This is achieved by rate control in Step 10. A buffer memory is generally provided for rate control. The amount of information to be stored is monitored so that the buffer memory does not overflow, and the amount of information to be generated is reduced before the buffer memory overflows. In more detail, the number of bits which represent the DCT coefficient is reduced by roughening the quantization characteristics in Step 3.

FIG. 2B shows decompression (decode) processing of the compressed moving image. The decode processing is achieved by inversely performing the encode processing shown in FIG. 2A in the reverse order. A “postfilter” shown in FIG. 2B is a filter for eliminating block noise. In the decode processing, VLC decoding (Step 1), reverse scanning (Step 2), and inverse AC/DC prediction (Step 3) are processed by the software, and processing after inverse quantization is processed by the hardware (Steps 4 to 8).

Configuration and Operation for Decompression of Compressed Image

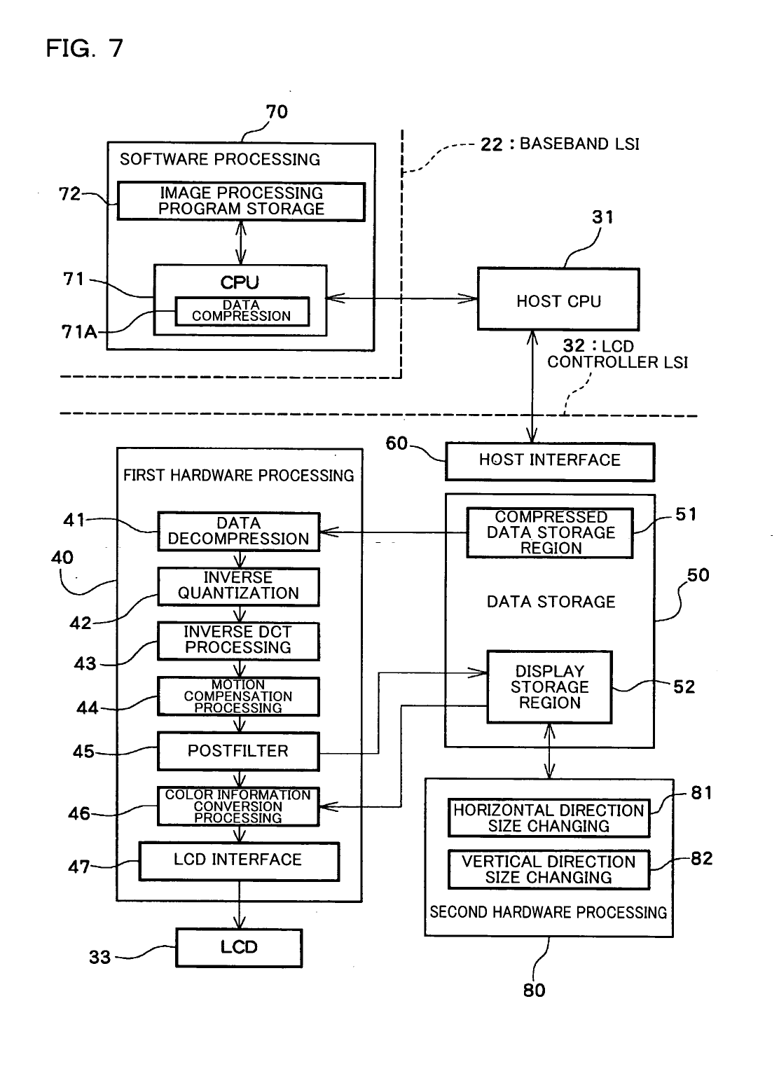

FIG. 7 is a functional block diagram of the LCD controller LSI 32 shown in FIG. 1. FIG. 7 shows hardware relating to a decode processing section of the compressed moving image and an image size changing section. The LCD controller LSI 32 includes a first hardware processing section 40 which performs Steps 4 to 8 shown in FIG. 2B, a data storage section 50, and a second hardware processing section 80 which changes the image size. The second hardware processing section 80 includes a horizontal direction size changing section 81 and a vertical direction size changing section 82. The LCD controller LSI 32 is connected with the host CPU 31 through a host interface 60. A software processing section 70 is provided in the baseband LSI 22. The software processing section 70 performs Steps 1 to 3 shown in FIG. 2B. The software processing section 70 is connected with the host CPU 31.

The software processing section 70 is described below. The software processing section 70 includes a CPU 71 and an image processing program storage section 72 as hardware. The CPU 71 performs Steps 1 to 3 shown in FIG. 2B for a compressed moving image input through the antenna 21 shown in FIG. 1 according to an image processing program stored in the storage section 72. The CPU 71 also functions as a data compression section 71A which compresses the processed data in Step 3 shown in FIG. 2B. The compressed data is stored in a compressed data storage region 51 provided in the data storage section 50 (SRAM, for example) in the LCD controller 32 through the host CPU 31 and the host interface 60.

The first hardware processing section 40 provided in the LCD controller 32 includes a data decompression section 41 which decompresses the compressed data from the compressed data storage region 51. Processing sections 42 to 45 for performing each stage of the processing in Steps 4 to 7 shown in FIG. 2B are provided in the first hardware processing section 40. The moving image data from which block noise is eliminated by using the postfilter 45 is stored in a display storage region 52 in the data storage section 50. A color information conversion processing section 46 performs YUV/RGB conversion in Step 8 shown in FIG. 2B based on the image information stored in the display storage region 52. The output from the processing section 46 is supplied to the LCD 33 through an LCD interface 47 and used to drive the display. The display storage region 52 has the capacity for storing a moving image for at least one frame. The display storage region 52 preferably has the capacity for storing a moving image for two frames so that the moving image can be displayed more smoothly.

Principle of Changing Image Size

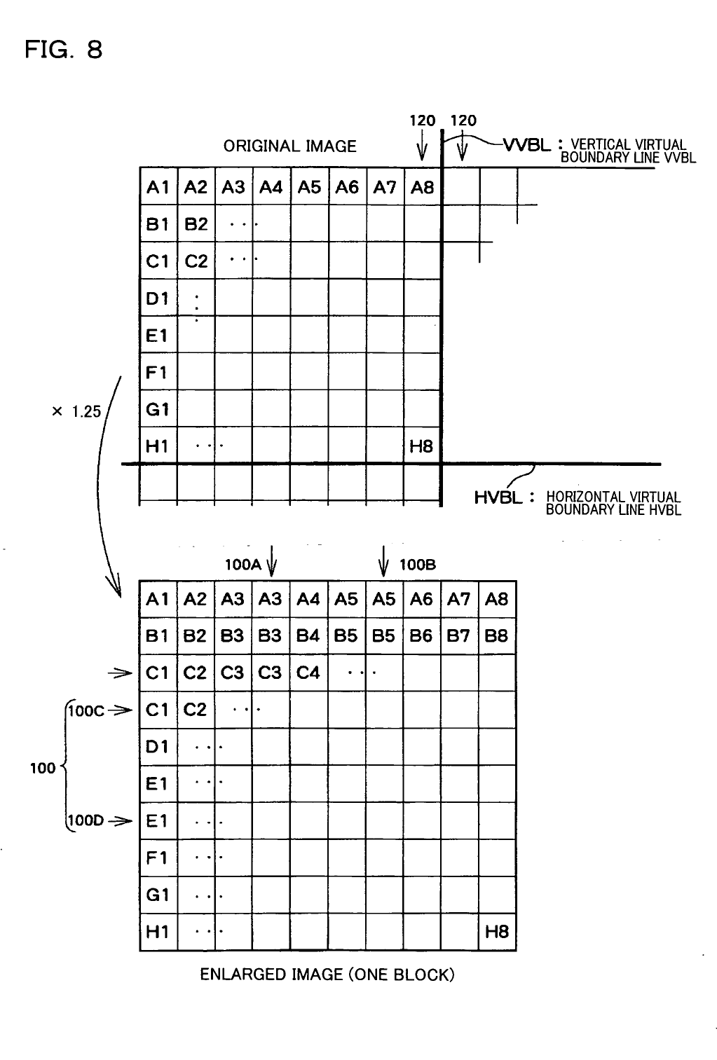

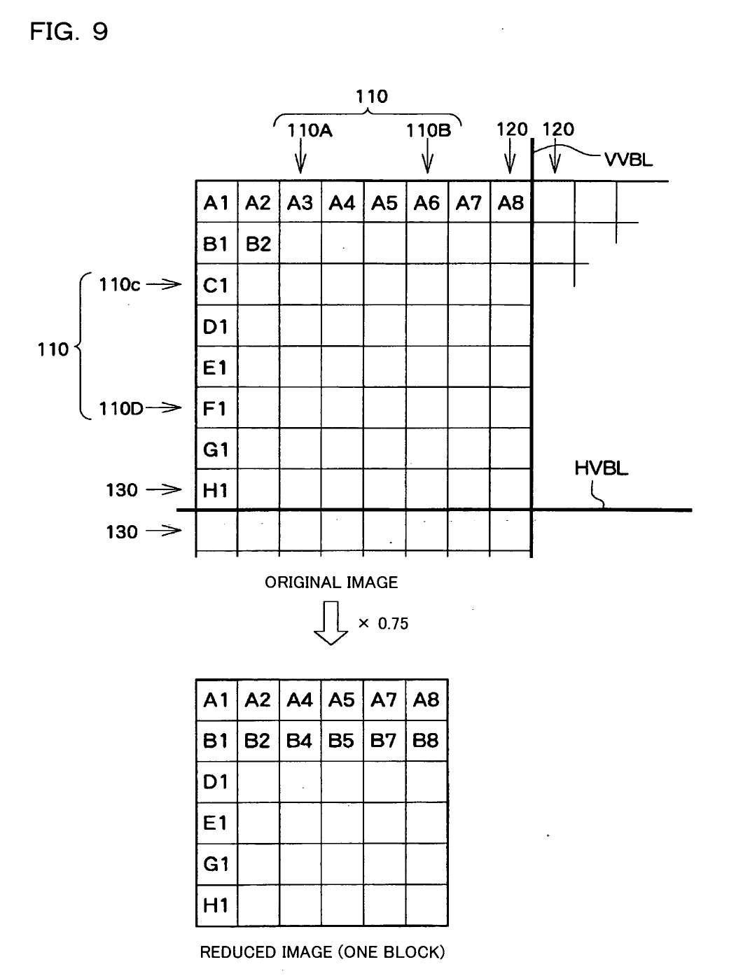

The principle of changing the image size in the second hardware processing section 80 which changes the image size is described below with reference to FIGS. 8 and 9. FIG. 8 shows an operation principle of increasing the original image size by 1.25, and FIG. 9 shows an operation principle of reducing the original image size to 0.75.

As shown in FIG. 8, in order to increase the original image size by 1.25 lengthwise and breadthwise, the number of pixels in one block is increased from 8×8 pixels to 10×10 pixels. As shown in FIG. 8, data in two pixels among the first to eighth pixels may be repeatedly used as data in two interpolation pixels 100 lengthwise and breadthwise in one block (hereinafter called “pixel doubling”).

As shown in FIG. 9, in order to reduce the original image size to 0.75 lengthwise and breadthwise, two pixels among the first to eighth pixels are thinned out as thinning pixels 110 lengthwise and breadthwise in one block to omit data for two pixels.

In this embodiment, as shown in FIGS. 8 and 9, each block (unit area) of the original image includes a plurality of first boundary pixels 120 arranged along a vertical virtual boundary line VVBL between two blocks adjacent in the horizontal direction in one frame. Each block includes a plurality of second boundary pixels 130 arranged along a horizontal virtual boundary line HVBL between two blocks adjacent in the vertical direction in one frame.

In the horizontal direction of the image shown in FIG. 8 which shows an enlarged image, horizontal interpolation pixels 100A and 100B are provided between pixels other than the first boundary pixels 120. In FIG. 8, the first horizontal interpolation pixels 100A are provided between the second pixels (A2, for example) and the third pixels (A3, for example) in the horizontal direction, and the second horizontal interpolation pixels 100B are provided between the sixth pixels (A6, for example) and the seventh pixels (A7, for example) in the horizontal direction in one block of the original image. In FIG. 8, data in the first and second horizontal interpolation pixels 100A and 100B is formed by doubling data in the second pixels (A2, for example) or the sixth pixels (A6, for example) in the horizontal direction.

In the vertical direction of the image shown in FIG. 8 which shows an enlarged image, vertical interpolation pixels 100C and 100D are provided between pixels other than the second boundary pixels 130. In FIG. 8, the first vertical interpolation pixels 100C are provided between the third pixels (C1, for example) and the fourth pixels (D1, for example) in the vertical direction, and the second vertical interpolation pixels 100D are provided between the fifth pixels (E1, for example) and the sixth pixels (F1, for example) in the vertical direction in one block of the original image. In FIG. 8, data in the first and second vertical interpolation pixels 100C and 100D is formed by doubling data in the third pixels (C1, for example) or the fifth pixels (E1, for example) in the vertical direction.

In the horizontal direction of the image shown in FIG. 9 which shows a reduced image, two pixels other than the first boundary pixels 120 are specified as horizontal thinning pixels 110A and 110B and thinned out. In FIG. 9, the first horizontal thinning pixels 110A (A3, B3, . . . , and H3) in the third column in the horizontal direction and the second horizontal thinning pixels 110B (A6, B6, . . . , and H6) in the sixth column in the horizontal direction in one block of the original image are thinned out.

In the vertical direction of the image shown in FIG. 9 which shows a reduced image, two pixels other than the second boundary pixels 130 are specified as vertical interpolation pixels 110C and 110D and thinned out. In FIG. 9, the first vertical thinning pixels 110C (C1, C2, . . . , and C8) in the third row in the vertical direction and the second vertical thinning pixels 110D (F1, F2, . . . , and F8) in the sixth row in the vertical direction in one block of the original image are thinned out.

When the size of the original image is increased or reduced in the horizontal direction, if data is interpolated by using data in the first boundary pixels 120, or the first boundary pixels 120 are thinned out, the boundary between two unit areas is emphasized, whereby the vertical virtual boundary line VVBL becomes conspicuous on the screen. In this embodiment, since data in the first boundary pixels 120 is prevented from being used as interpolation data or thinned out, the image quality can be maintained even if the image size is increased or reduced in the horizontal direction.

When the size of the original image is increased or reduced in the vertical direction, if data is interpolated using data in the second boundary pixels 130, or the second boundary pixels 130 are thinned out, the boundary between two unit areas is emphasized, whereby the horizontal virtual boundary line HVBL becomes conspicuous on the screen. In this embodiment, since data in the second boundary pixels 130 is prevented from being used as interpolation data or thinned out, the image quality can be maintained even if the image size is increased or reduced in the vertical direction.

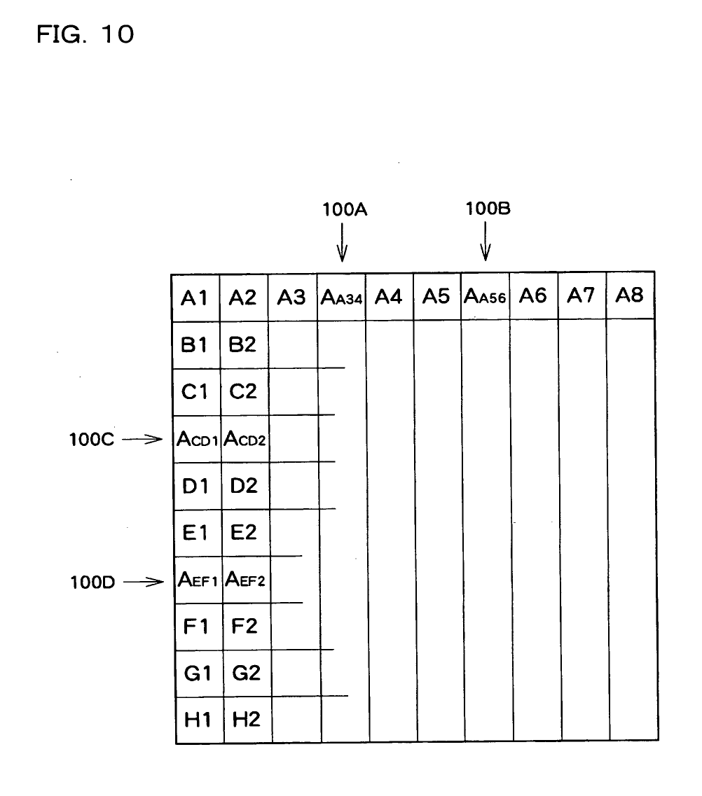

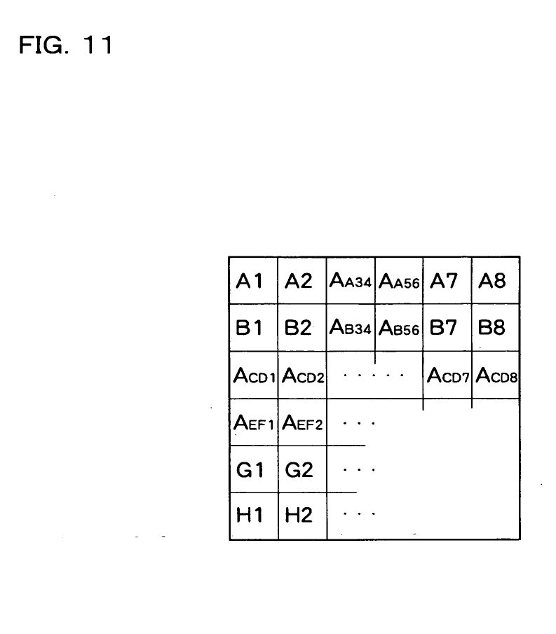

FIGS. 10 and 11 show a scaling operation when a data averaging method is employed in FIGS. 8 and 9. In FIG. 10, the interpolation pixels 100A to 100D include data obtained by averaging the data in the previous and subsequent pixels.

Interpolation pixel data A_{A34} between pixel data A3 and A4 in the third and fifth columns in the horizontal direction in one block of the enlarged image is expressed as “A_{A34}=(A3+A4)/2”. Iinterpolation pixel data A_{CDI} between pixel data C1 and D1 in the third and fifth rows in the vertical direction in one block is expressed as A_{CDI}=(C1+D1)/2.

Emphasis of brightness or color can be reduced by averaging data in pixels adjacent to the interpolation pixel to obtain data in the interpolation pixel, in comparison with the case of doubling the pixel data as shown in FIG. 8. In the area in which color or brightness changes to a large extent, such as an outline area, the change becomes smooth, whereby the image quality of the original image can be maintained.

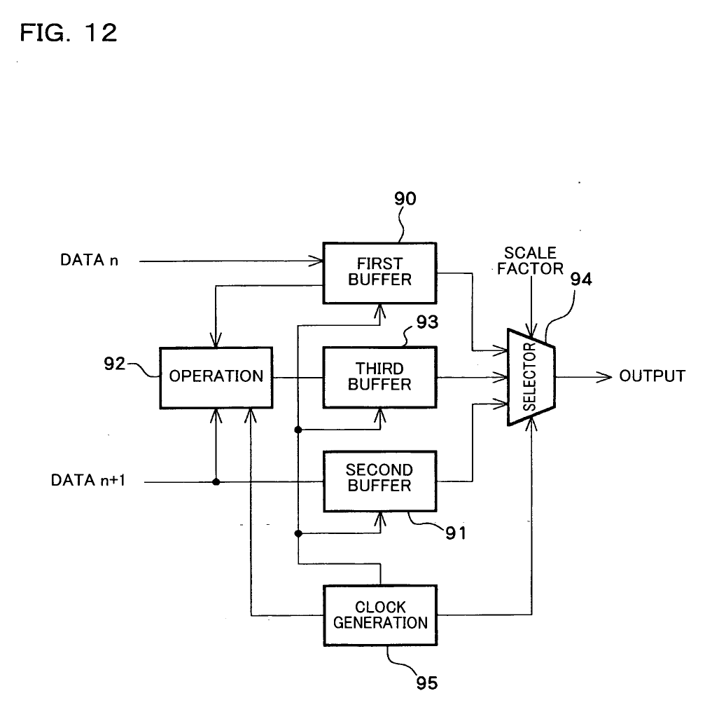

The thinning pixel in FIG. 9 and the pixel adjacent to the thinning pixel are averaged as shown in FIG. 11. For example, the thinning pixel data A3 in FIG. 9 and the pixel data A4 on the left of the thinning pixel data A3 are averaged to the pixel data A_{A34} in FIG. 11. The pixel data A_{A34} is expressed as “A_{A34}=(A3+A4)/2”. The image quality of the original image can be maintained in the reduced image in the same manner as in the enlarged image by averaging the thinning pixel data and the remaining pixel data. Configuration and operation of second hardware processing section FIG. 12 is a block diagram showing a configuration provided in at least one of the horizontal direction size changing section 81 and the vertical direction size changing section 82 provided in the second hardware processing section 80 shown in FIG. 7.

In FIG. 12, data in the n-th pixel (n is a positive integer) in the horizontal or vertical direction is input to a first buffer 90 from the display storage region 52 shown in FIG. 7. Data in the (n+1)th pixel in the horizontal or vertical direction is input to a second buffer 91 from the display storage region 52 shown in FIG. 7. An operation section 92 averages the data in the n-th pixel and the data in the (n+1)th pixel. The output from the operation section 92 is input to a third buffer 93. A selector 94 selects one of the outputs from the first to third buffers 90, 91, and 93. The output from the selector 94 is stored at a predetermined address in the display storage region 52 shown in FIG. 7. The blocks 90 to 94 operate in synchronization with a clock signal from a clock generation section 95.

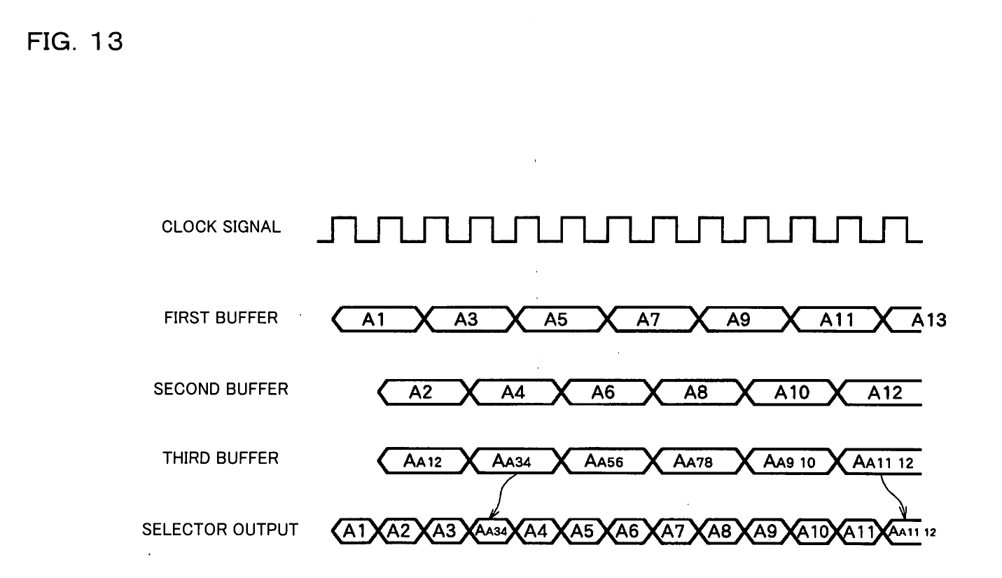

The basic operation of the image size changing section shown in FIG. 12 is described below with reference to FIG. 13. FIG. 13 shows an operation in the case where the image size is increased by interpolating the interpolation pixel data A_{A34} between the third and fourth pixel data A3 and A4 in one block (scale factor: 9/8), as indicated by the selector output.

As shown in FIG. 13, data is written into the first to third buffers 90, 91, and 93 for a period of two clock signals in principle, and the selector 94 selects and outputs the output from one of the first to third buffers 90, 91, and 93 in synchronization with the clock signal.

In more detail, the pixel data A1 is written into the first buffer 90, and the pixel data A1 from the first buffer 90 is input to the operation section 92 when the subsequent pixel data A2 is input to the operation section 92. The operation section 92 averages the pixel data as expressed by “A_{A12}=(A1+A2)/2”. The averaged data A_{A12} is written into the third buffer 93 when the pixel data A2 is written into the second buffer 91 in synchronization with the second clock signal. The pixel data is alternately written into the first and second buffers 90 and 91, and the above-described operation is repeatedly performed.

The selector 94 selects and outputs the pixel data A1 written into the first buffer 90 in synchronization with the first clock signal. The selector 94 selects the pixel data A2 from the second buffer 91 in synchronization with the next clock signal. The selector 94 selects the pixel data A3 from the first buffer 90 in synchronization with the third clock signal. The selector 94 then selects the averaged data A_{A34} from the third buffer 93 as interpolation pixel data. This operation is repeatedly performed in each block.

Once the interpolation pixel data is selected, the subsequent clock synchronization must be corrected. Therefore, the pixel data A12 and A13 must be written into the corresponding buffers for a period of three clock signals as an exceptional case, although not shown in FIG. 13.

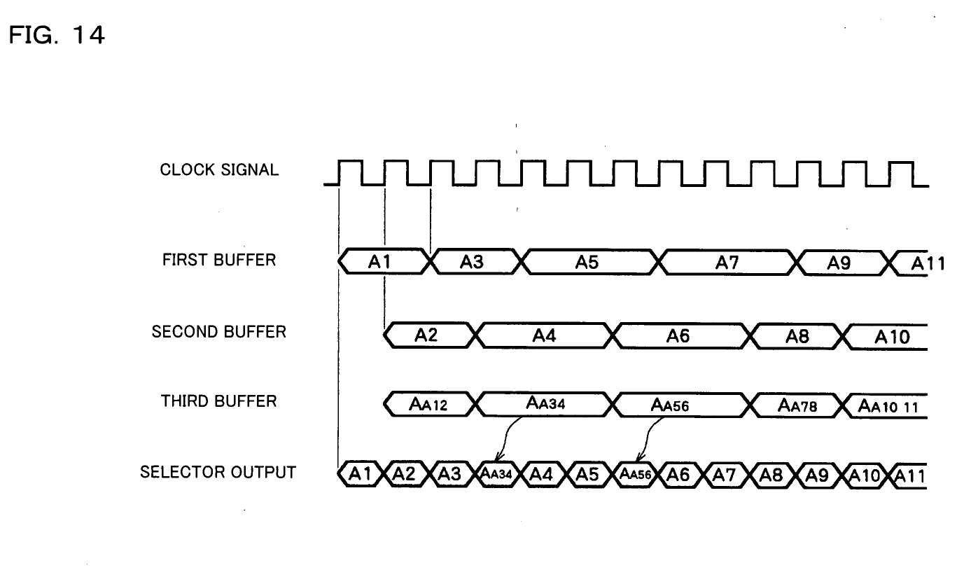

A case of generating the image increased by 1.25 shown in FIG. 10 using the above-described exceptional operation is described below with reference to FIG. 14.

In FIG. 14, it is necessary to generate the data A_{A34} and A_{A56} in two interpolation pixels 100A and 110B in the horizontal direction in one block, as described with reference to FIG. 10. Therefore, the pixel data A4 to A7 and the averaged data A_{A34} and A_{A56} are stored in the corresponding buffers for a period of three clock signals. If the pixel data A5 is stored for a period of two clock signals, the pixel data A5 does not exist in the buffer when generating the averaged data A_{A56}. The pixel data other than the pixel data A5 is also stored in the corresponding buffer for a period of three clock signals for timing.

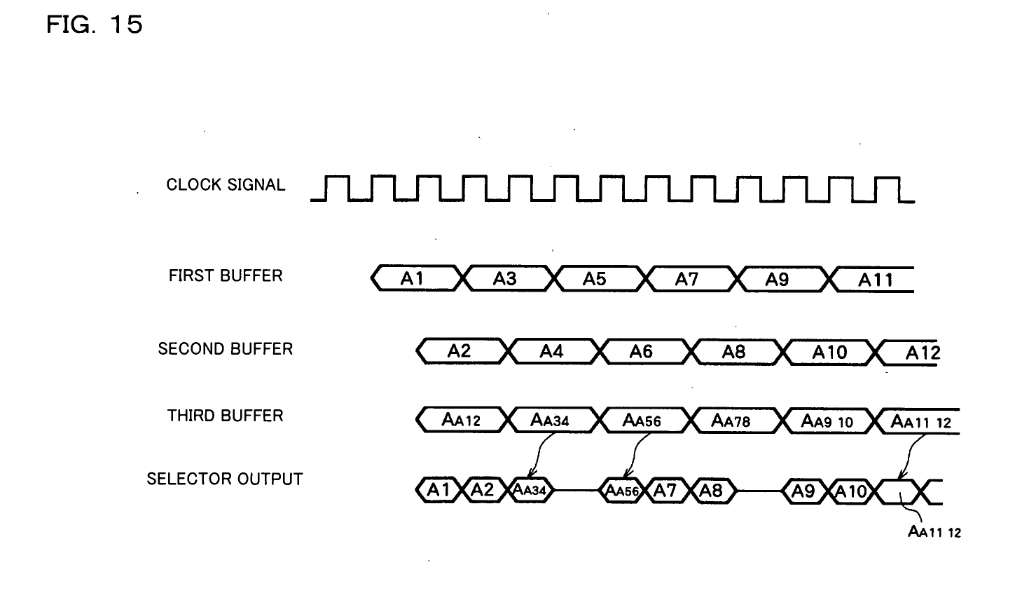

FIG. 15 shows the operation in the case of generating the image reduced to 0.75 shown in FIG. 11. In this case, data may be stored in the buffers 90, 91, and 93 for a period of two clock signals. However, after the selector 94 selects the averaged data A_{A34}, the subsequent pixel data is selected after waiting for a period of one clock signal, as shown in FIG. 15.

In this embodiment, the image size of a color original image made up of YUV components is increased or reduced as shown in FIG. 7. This is because conversion from YUV to RGB is performed before outputting the image to the LCD 33 in FIG. 7. However, an RGB image may be used as the original image.

In the case of using the original image made up of YUV components, the Y component dominates the sense of color to a large extent in comparison with the U and V components. Therefore, interpolation pixel data is obtained by averaging as shown in FIG. 10 only for the Y component, and the preceding pixel is doubled as shown in FIG. 8 for the U and V components without averaging data. This reduces the averaging operation target, whereby the processing speed can be increased.

The present invention is not limited to the above-described embodiment. Various modifications are possible within the spirit and scope of the present invention. The electronic instrument to which the present invention is applied is not limited to the portable telephone. The present invention can be suitably applied to other electronic instruments such as portable instruments. The compression/decompression method which is the processing history of the original image is not limited to the MPEG-4 method. The compression/decompression method may be another compression/decompression method including processing in units of unit areas. The above-described embodiment illustrates the case where horizontal increasing scale factor=vertical increasing scale factor=1.25, and horizontal reduction scale factor=vertical reduction scale factor=0.75. However, these scale factors are only examples. The present invention may be applied to various scale factors which can be set depending on the instrument. It is not necessary that the scale factors be the same in the vertical and horizontal directions.

For example, when increasing the image size by 1.25, interpolation pixels may be arbitrarily set for pixels (12345678) in one block of the original image at positions other than the boundary pixels, such as 1223456778 or 1233456678. When reducing the image size to 0.75, thinning pixels may be arbitrarily set at positions other than the boundary pixels, such as 124578 or 134568.

1. A method of changing an image size, comprising:
storing an original image that has been processed in units of unit areas which are defined by dividing one frame; and
changing a size of the original image at least in a horizontal direction by interpolating data in an interpolation pixel between predetermined pixels in each of the unit areas of the original image according to a set horizontal increasing scale factor,
wherein each of the unit areas includes a plurality of first boundary pixels arranged along a vertical virtual boundary line between two of the unit areas adjacent in the horizontal direction in the frame, and
wherein, in the image size changing step, the interpolation pixel is set between pixels other than the first boundary pixels.

2. The method of changing an image size as defined in claim 1,
wherein each of the unit areas includes a plurality of second boundary pixels arranged along a horizontal virtual boundary line between two of the unit areas adjacent in the vertical direction in the frame, and
wherein the image size changing step further includes increasing size of the original image in the vertical direction by setting the interpolation pixel between pixels other than the second boundary pixels according to a set vertical increasing scale factor.

3. The method of changing an image size as defined in claim 1,
wherein the image size changing step further includes reducing and changing size of the original image in the horizontal direction by thinning out data in a thinning pixel according to a set horizontal reduction scale factor, the thinning pixel being a pixel other than the first boundary pixels in each of the unit areas.

4. The method of changing an image size as defined in claim 1,
wherein each of the unit areas includes a plurality of second boundary pixels arranged along a horizontal virtual boundary line between two of the unit areas adjacent in the horizontal direction in the frame, and
wherein the image size changing step further includes reducing and changing size of the original image in the vertical direction by thinning out data in a thinning pixel according to a set vertical reduction scale factor, the thinning pixel being a pixel other than the second boundary pixels in each of the unit areas.

5. The method of changing an image size as defined in claim 1,
wherein the original image has a processing history of compression or decompression using an MPEG method.

6. The method of changing an image size as defined in claim 5,
wherein the original image has been processed in units of 8×8 pixel blocks during a discrete cosine transform or inverse discrete cosine transform, and
wherein each of the unit areas corresponds to the block.

7. The method of changing an image size as defined in claim 5,
wherein the original image has been processed in units of 16×16 pixel macroblocks during motion compensation or inverse motion compensation, and
wherein each of the unit areas corresponds to the macroblock.

8. The method of changing an image size as defined in claim 1,
wherein the data interpolation step includes obtaining data in the interpolation pixel by averaging data in pixels adjacent to the interpolation pixel.

9. The method of changing an image size as defined in claim 3,
wherein the data thinning step includes averaging data in a pixel that is adjacent to the thinning pixel and other than the first or second boundary pixels by using the thinning pixel.

10. The method of changing an image size as defined in claim 8,
wherein the original image is a color image made up of YUV components, and
wherein the averaging step is performed for only the Y component.

11. A device for changing an image size, comprising:
a storage circuit which stores an original image that has been processed in units of unit areas which are defined by dividing one frame; and
an image size changing circuit which changes a size of the original image from the storage circuit at least in a horizontal direction by interpolating data in an interpolation pixel between predetermined pixels in each of the unit areas of the original image according to a set horizontal increasing scale factor,
wherein each of the unit areas includes a plurality of first boundary pixels arranged along a vertical virtual boundary line between two of the unit areas adjacent in the horizontal direction in the frame, and
wherein the image size changing circuit sets the interpolation pixel between pixels other than the first boundary pixels.

12. The device changing an image size as defined in claim 11,
wherein each of the unit areas includes a plurality of second boundary pixels arranged along a horizontal virtual boundary line between two of the unit areas adjacent in the vertical direction in the frame, and
wherein the image size changing circuit increases size of the original image in the vertical direction by setting the interpolation pixel between pixels other than the second boundary pixels according to a set vertical increasing scale factor.

13. The device for changing an image size as defined in claim 12,
wherein the image size changing circuit reduces and changes size of the original image in the horizontal direction by thinning out data in a thinning pixel according to a set horizontal reduction scale factor, the thinning pixel being a pixel other than the first boundary pixels in each of the unit areas.

14. The device for changing an image size as defined in claim 13,
wherein the image size changing circuit reduces and changes size of the original image in the vertical direction by thinning out data in a thinning pixel according to a set vertical reduction scale factor, the thinning pixel being a pixel other than the second boundary pixels in each of the unit areas.

15. The device for changing an image size as defined in claim 14,
wherein the image size changing circuit includes:
horizontal direction changing circuit which changes the image size in the horizontal direction; and
vertical direction changing circuit which changes the image size in the vertical direction, and
wherein at least one of the horizontal direction changing circuit and the vertical direction changing circuit includes:
a first buffer to which data in the n-th pixel (n is a positive integer) in the horizontal or vertical direction is input;
a second buffer to which data in the (n+1)th pixel in the horizontal or vertical direction is input;
an operation section which averages the data in the n-th pixel and the (n+1)th pixel;
a third buffer to which an output from the operation section is input; and
a selector which selects one of outputs from the first to third buffers.

16. The device for changing an image size as defined in claim 15, wherein, when a scale factor is an increasing scale factor, the selector selects and outputs the output from the third buffer to the interpolation pixel.

17. The device for changing an image size as defined in claim 14, wherein, when a scale factor is a reduction scale factor, the selector selects and outputs the output from the third buffer to a pixel adjacent to the thinning pixel.
